(19) United States
(12) Patent Application Publication
(10) Pub. No.: US 2013/0300100 A1
(43) Pub. Date: Nov. 14, 2013

(54) Medical Tape with Warning Indicators

(71) Applicant: Grace Padilla-Kastenberg, Oak Park, CA (US)

(72) Inventor: Grace Padilla-Kastenberg, Oak Park, CA (US)

(21) Appl. No.: 13/829,462

(22) Filed: Mar. 14, 2013

Related U.S. Application Data
(60) Provisional application No. 61/644,883, filed on May 9, 2012.

(51) Int. Cl. B42D 15/00

(52) U.S. Cl. CPC B42D 15/00
USPC 283/67; 283/62

(57) ABSTRACT

Adhesive medical tape with warning indicators. The warning indicators can indicate the presence of a dangerous condition in a medical setting, such as the presence of sharp needles or that a patient is infected with a bloodborne pathogen. Viewers who see the warning indicators can alter their behavior to avoid the dangerous condition when treating patients.

### CLAIM OF PRIORITY

This Application claims priority under 35 U.S.C. §119(e) from earlier filed U.S. Provisional Application Ser. No. 61/644,883, filed May 9, 2012, by Grace Padilla-Kastenberg, the entirety of which is incorporated herein by reference.

### BACKGROUND

1. Field of the Invention

The present device relates to the field of medical devices, particularly medical tape comprising warning indicators.

2. Background

It is common in the healthcare industry for workers to interact with sharp objects such as needles while caring for patients. Unfortunately, it is also common for these sharp objects to accidentally injure healthcare workers. Needlesticks are injuries that result from the puncturing of skin by needles or other sharp objects during the placement, removal, or disposal of needles in healthcare settings. OHSA estimates that 5.6 million United States healthcare workers are at risk of being injured through accidental needlesticks. In U.S. hospitals alone there are 385,000 needlestick and other sharps-related injuries annually, an average of over 1000 injuries per day. When considering all healthcare personnel, including non-hospital staff, private clinics, home healthcare staff, and long-term care facilities, there are between 600,000-800,000 sharps and needlestick injuries per year. These percutaneous injuries are a serious problem, and can lead to medical personnel being exposed to bloodborne pathogens such as HIV, Hepatitis B and C, syphilis, and other diseases. The costs of dealing with the accidental exposure to such pathogens can be extremely high. The cost of testing for infection, providing medication, and providing disability for infected workers can exceed $1 million per infection. Injured workers may also suffer psychological effects between the initial percutaneous injury and the determination of whether or not they have been infected with a pathogen.

Although healthcare workers are aware of the dangers of needlesticks and other sharps-related injuries, the fast paced nature of modern medical care environments can lead to workers overlooking the danger. Currently, blank medical tape is often used to secure a needle to a patient's skin after the needle has been inserted percutaneously, but the blank tape provides little or no information to a healthcare worker who later treats or comes into contact with the patient. For example, a new worker may not realize that a sharp object such as a needle is underneath the medical tape, or that a patient is infected with a certain disease when first caring for the patient. This lack of knowledge can lead to the worker not recognizing the potential for an accidental needlestick and that he or she should take extra care when tending to the patient. Even workers who are familiar with a patient's medical history may forget that a needle is present, or simply have other things on their minds and not be thinking about the danger posed by a hidden needle. Similarly, healthcare workers can become desensitized to potential needle hazards.

A healthcare worker's ignorance of the presence of needles can also pose problems for patients. When a healthcare worker is unaware that a needle has been inserted into a patient, the healthcare worker can accidentally dislodge the needle from the patient. Accidental needle dislodgement can cause significant blood loss or prevent the delivery of medication and/or fluids. In some cases the healthcare worker and/or patient may not realize that the needle has been dislodged and that care has been disrupted. This scenario has potentially life threatening ramifications.

What is needed is medical tape with warning indicators. The warning indicators can notify or remind healthcare workers that a certain condition is present. For example, the warning indicators can convey that a needle is present under the medical tape; that the patient is infected with a certain type of disease; and/or that any other condition is present. The warning indicators can serve as a quick and non-intrusive reminder to healthcare workers that they should act to protect themselves and the patient when the condition is present. For example, a healthcare worker can see the warning indicators on the medical tape, understand from the warning indicators that a condition is present, and act to avoid the dangers of that condition, especially when swift action is necessary to care for a patient and the danger posed by the condition may not otherwise be at the forefront of the healthcare workers' minds.

### BRIEF DESCRIPTION OF THE DRAWINGS

FIG. 1A depicts a top view of an exemplary embodiment of notifying medical tape with a plurality of warning indicators.

FIG. 1B depicts a bottom view of an exemplary embodiment of notifying medical tape with a backing.

FIG. 2 depicts an isometric view of an exemplary embodiment of notifying medical tape in a roll.

FIG. 3 depicts a top view of an exemplary embodiment of notifying medical tape with a single warning indicator.

FIG. 4 depicts an exemplary embodiment of notifying medical tape in use.

### DETAILED DESCRIPTION

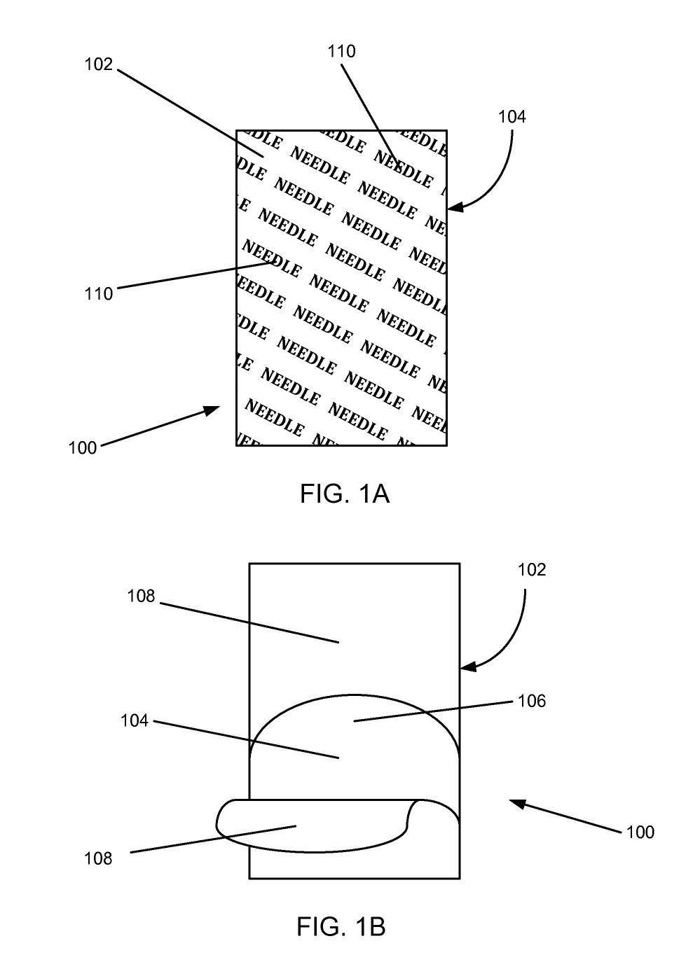

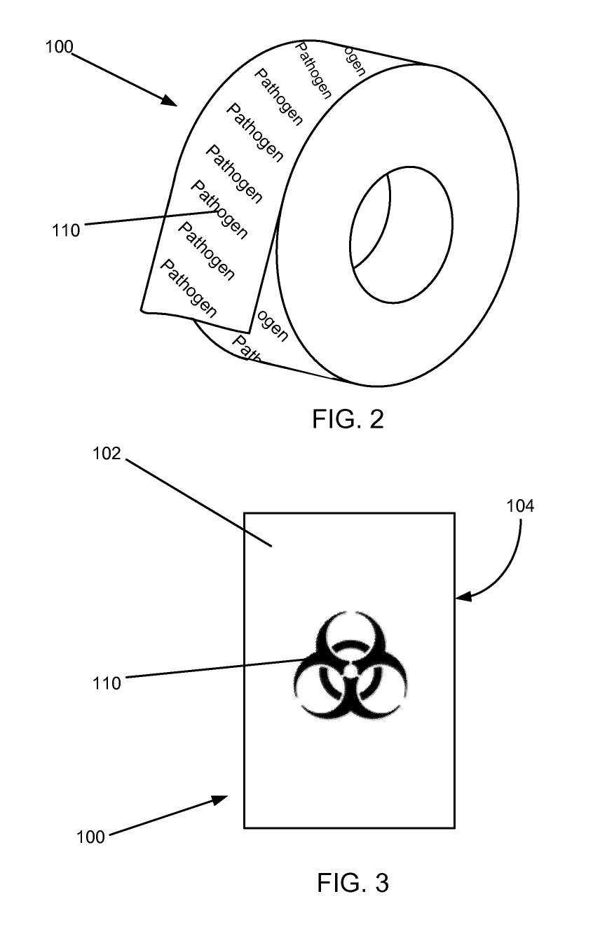

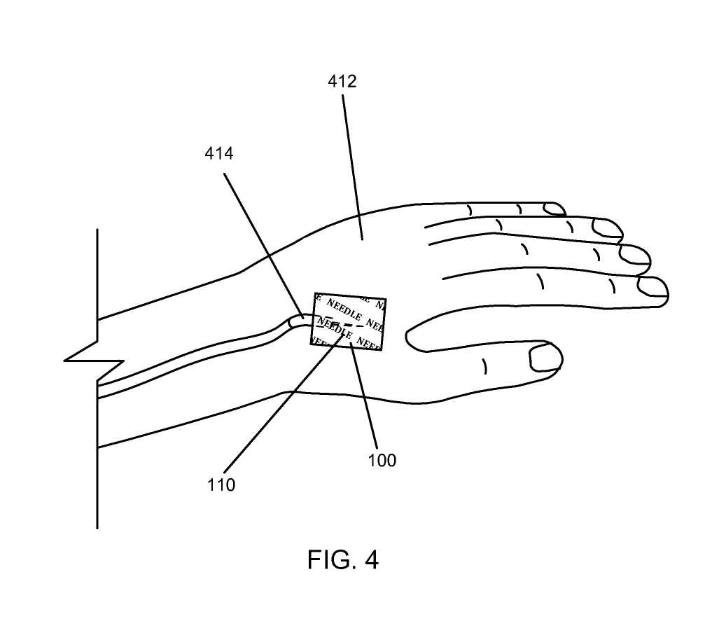

FIG. 1A depicts a top view of an exemplary embodiment of a piece of notifying medical tape 100. FIG. 1B depicts a bottom view of an exemplary embodiment of a piece of notifying medical tape 100. The notifying medical tape 100 can have an upper face 102 and a lower face 104. The sides of the notifying medical tape 100 can be die cut, radial cut, laser cut, or be cut by any other process. In some embodiments, the notifying medical tape 100 can be pre-cut into strips of a size suitable to secure a needle to a patient's skin after the needle has been inserted percutaneously, as shown in FIGS. 1A, 1B and 4. In other embodiments, the notifying medical tape 100 can be an elongated strip packaged into a roll, as shown in FIG. 2. In still other embodiments, the notifying medical tape 100 can be rectangular, circular, oval, butterfly-shaped, have cut-out sections, or have any other shape or size.

In some embodiments, the notifying medical tape 100 can comprise a single layer of material. In other embodiments, the notifying medical tape 100 can comprise a plurality of layers. In some of these embodiments, one or more layers can be waterproof or water-resistant, and/or one or more other layers can be moisture absorbent.

In some embodiments, the notifying medical tape 100 can be transparent or translucent. In other embodiments, the notifying medical tape 100 can be opaque. In some embodiments, the notifying medical tape 100 can comprise polyethylene. In other embodiments, the notifying medical tape 100 can comprise film, paper, plastic, cotton, polyester, silk, and/or any other desired material. In some embodiments, the surface of the notifying medical tape 100 can be smooth. In other embodiments, the surface of the notifying medical tape 100 can be textured.

The lower face 104 of the notifying medical tape 100 can comprise an adhesive surface 106. In some embodiments the adhesive surface 106 can be integral with the lower face 104. In other embodiments, the lower face 104 can be coupled with a separate layer comprising an adhesive surface 106. In some embodiments, the adhesive surface 106 can comprise a pressure sensitive adhesive. In some embodiments, the notifying medical tape 100 and/or the adhesive surface 106 can be hypoallergenic and/or be impregnated with anti-bacterial properties.

In some embodiments, the adhesive surface 106 can cover the entire lower face 104. In alternate embodiments, the adhesive surface 106 can cover one or more edges of the lower face 104 without covering the entire lower face 104. By way of a non-limiting example, in some embodiments the adhesive surface 106 can cover the edges of the lower face 104, such that the center of the lower face 104 is not covered by adhesives.

In some embodiments, the adhesive surface 106 can initially be covered by a removable backing 108. The removable backing 108 can comprise one or more pieces of non-adhesive material that can be removed from the adhesive surface 106. By way of a non-limiting example, the removable backing 108 can be a butterfly backing that can be peeled off the adhesive surface 106.

The upper face 102 of the notifying medical tape 100 can comprise one or more warning indicators 110. The warning indicators 110 can be marks that can convey information pertaining to one or more conditions related to a patient that can be present in a medical environment. The conditions can be one or more safety hazards, such as the presence of needles or other sharps, the presence of electrodes, a diagnosis of a patient, the infection status of a patient, or any other type of condition related to a patient that can be present in a medical environment. In some embodiments, the condition can have the potential to impact a third party after the medical tape has been affixed to a patient. By way of a non-limiting example, the condition can be the presence of a needle inserted into a patient's skin underneath the notifying medical tape 100, which could impact a third party such as a healthcare worker who is otherwise unaware of the presence of the needle and could be injured by the needle, but who can become aware of the presence of the needle when viewing the warning indicators 110.

In some embodiments, the warning indicators 110 can be text. In other embodiments, the warning indicators 110 can be colors, color coding, symbols, designs, pictures, and/or any other types of marks or signals that are associated with the information to be conveyed. In some medical environments, a plurality of different embodiments of notifying medical tape 100 can be present, with each different embodiment comprising different warning indicators 110 corresponding to different conditions.

In embodiments in which the notifying medical tape 100 is transparent or translucent, the warning indicators 110 can be opaque, such that the warning indicators 110 can be visually distinctive from the rest of the notifying medical tape 100. In embodiments in which the notifying medical tape 100 is opaque, the warning indicators 110 can be one or more different colors than the rest of the notifying medical tape 100. In still other embodiments, one or more warning indicators 110 can be reactive to moisture, such that the warning indicators 110 can change color when wet. By way of a non-limiting example, the color of one or more warning indicators 110 can initially blend in with the rest of the notifying medical tape 100 such that the warning indicators 110 are not visible, but change color to a visually noticeable color when the notifying medical tape 100 is exposed to fluid, for instance when blood contacts the lower surface 104.

In some embodiments, the warning indicators 110 can convey specific information about one or more specific conditions. By way of non-limiting examples, the warning indicators 110 can read “Sharps” or “Needles” to indicate that a needle is present underneath the notifying medical tape 100, or “biohazard,” “BBP” or “Pathogens Present” to indicate that a patient is infected with a bloodborne pathogen.

In other embodiments, the warning indicators can convey general alert information about one or more conditions. By way of non-limiting examples, the warning indicators 110 can read “Caution,” “Alert,” or “Warning.”

In still other embodiments, the warning indicators 110 can be any other text, color, color coding, design, picture, or other type of signal. By way of a non-limiting example, the warning indicators 110 can be biohazard symbols, as shown in FIG. 3. By way of another non-limiting example, the warning indicator 110 can be a numeral indicating the step number of a surgical procedure.

In some embodiments, notifying medical tape 100 and/or warning indicators 110 of different colors can be used to signify different types of pathogens, varying levels of severity, different dangerous conditions, or any other information.

In some embodiments, the warning indicators 110 can be arranged in a repeating pattern on the upper face 102, as shown in FIG. 1A and FIG. 2. In some embodiments, the repeating pattern can be angled relative to the sides of the notifying medical tape 100, as shown in FIG. 1A and FIG. 2. In other embodiments, the warning indicators 110 can be positioned at the center of the upper face of a piece of notifying medical tape 100, as shown in FIG. 3.

FIG. 4 depicts an exemplary embodiment of the notifying medical tape 100 in use. In operation, when a user desires to convey information about a condition, the user can select the proper embodiment of notifying medical tape 100 that comprises warning indicators 110 corresponding to that condition. If present, the user can remove the backing 108. The user can affix the notifying medical tape 100 by contacting the adhesive surface 106 to a patient's skin 412 or other desired location, as shown in FIG. 4. By way of a non-limiting example, the adhesive surface 106 can be pressed against the entry point of a needle 414 into a patient's skin after the needle 414 has been inserted percutaneously, such that the notifying medical tape 100 can help keep the needle 414 in place into and/or against the patient's skin 412. The warning indicators 110 can serve as a notification and/or reminder that the condition is present when a viewer sees the warning indicators 110. If necessary, the viewer can then alter his or her behavior to avoid injuries and/or infection related to the condition.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A piece of medical tape, comprising:
a strip having an upper face and a lower face; and
an adhesive surface coupled with said lower face;
wherein said upper face has one or more warning indicators that convey information about a condition related to a patient in a medical environment, said condition having the potential to impact a third party.

2. The piece of medical tape of claim 1, wherein said condition is the presence of a needle in said patient's skin when said strip is affixed to said patient's skin over an insertion point of said needle into said patient's skin.

3. The piece of medical tape of claim 1, wherein said condition is the presence of a pathogen in said patient's blood when said strip is affixed to said patient's skin.

4. The piece of medical tape of claim 1, further comprising a removable backing coupled with said adhesive surface.

5. The piece of medical tape of claim 1, wherein said removable backing comprises a plurality of removable sections.

6. The piece of medical tape of claim 1, wherein said strip is a pre-cut into a rectangular shape.

7. The piece of medical tape of claim 6, wherein said strip is die cut.

8. The piece of medical tape of claim 1, wherein said strip is provided in a roll.

9. The piece of medical tape of claim 1, wherein said strip is transparent and said warning indicators are opaque.

10. The piece of medical tape of claim 1, wherein said strip is opaque and said warning indicators are one or more different colors than said strip.

11. A method of notifying a third party viewer about the presence of a condition, comprising:
selecting medical tape comprising one or more visual warning indicators signifying a condition related to a patient in a medical environment, wherein said condition has the potential to impact a third party viewer; and
using an adhesive surface coupled with said medical tape to affix said medical tape to said patient's skin in a manner that leaves said one or more visual warning indicators visible, such that when said third party viewer sees said warning indicators said third party viewer becomes aware of the presence of said condition.

12. The method of claim 11, wherein said condition is the presence of a needle in said patient's skin when said strip is affixed to said patient's skin over an insertion point of said needle into said patient's skin.

13. The method of claim 11, wherein said condition is the presence of a pathogen in said patient's blood when said strip is affixed to said patient's skin.
